(19) United States
(12) Patent Application Publication
(10) Pub. No.: US 2024/0428010 A1
(43) Pub. Date: Dec. 26, 2024

(54) TEXT REPRESENTATION VIA MULTI-RESOLUTION TEXT CLUSTERING IN NATURAL LANGUAGE PROCESSING

(71) Applicant: INTERNATIONAL BUSINESS MACHINES CORPORATION, ARMONK, NY (US)

(72) Inventors: Slavisa Sarafijanovic, Adliswil (CH); Charalampos Pozidis, Thalwil (CH)

(21) Appl. No.: 18/337,492

(22) Filed: Jun. 20, 2023

(51) Int. Cl. G06F 40/40; G06F 16/35; G06F 40/205; G06F 40/30

(52) U.S. Cl. CPC G06F 40/40; G06F 16/355; G06F 40/205; G06F 40/30

(57) ABSTRACT

A computer-implemented method for generating a fixed-size N-dimensional vector representation for a given document is disclosed. The method comprises extracting text-portions from a plurality of documents, embedding the extracted text-portions into fixed-sized K-dimensional text-portion vectors, clustering the text-portion vectors into N clusters C_1, C_2, . . . , C_N, generating an N-dimensional document vector E(D) for a document D by (i) associating its nth coordinate value E(D)_n to the nth cluster C_n, and (ii) if not previously done for the document D extracting text-portions from the document D and embedding the extracted text-portions into K-dimensional text-portion vectors, and (iii) setting the values E(D)_n based on similarity matching score values between the text-portion vectors of the document D and text-portions vectors of the N clusters.

### BACKGROUND

The invention relates generally to a method for natural language processing, and more specifically, to a computer-implemented method for generating a fixed-size vector representation for a given document. The invention relates further to an embedding system for generating a fixed-size vector representation for a given document, and a computer program product.

Significant improvements have been made in Natural Language Processing (NPL), a technique to improve the human machine interface (HMI). Known NLP techniques use various approaches to represent text or documents; before applying various methods for typical NLP application tasks such as (i) finding similar documents or similar text parts in other documents, (ii) grouping (i.e., clustering) similar documents together, (iii) classifying text or documents, (iv) named entity recognition, (v) text summarization, etc.

The NLP state of the art shows that the choice of text and document representation may greatly impact quantitative NLP aspects. The accuracy and computational complexity of the methods used is primarily influenced by the selected type of document representation. Additionally, qualitative aspects such as explainability of the results are impacted.

Currently the most prominent text representation techniques are based on word and sentence embeddings, where the words or sentences are represented by multi-dimensional numeric vectors.

The main problem with the existing NLP methods built on top of these embeddings is the inherent and unfavorable tradeoff between the NLP tasks accuracy on one side and practical usability due to computational complexity and scaling limitations on the other side, when they are used in NLP applications with multi-sentence documents.

This trade-off is governed by the granularity of the generated and retained embeddings—e.g., at word, sentence, paragraph, or document level—when representing a multi-sentence text or a document. More specifically, some of the existing NLP methods represent a multi-sentence text or document with the potentially weighted average of the embeddings of their words or sentences, resulting in a low-resolution document representation (a single average vector represents an entire document) and consequently lower accuracy.

On the other side, representing a multi-sentence document with a single fixed-size vector is often desirable for fast similarity matching or use of advanced downstream NLP processing such as via neural networks.

Other existing NLP methods represent a document with a collection of the embedding vectors corresponding to the document words or sentences (or paragraphs), and then apply advanced algorithms to compare the vectors between two documents and evaluate the documents similarity. These algorithms are computationally expensive and do not scale well.

Optimizations have been developed for improved computation cost and speed, however these optimizations assume limited vocabulary of words or sentences.

The limited vocabulary assumption is practical for word embeddings, but not for sentence embeddings in larger datasets (because the number of different sentences grows fast with the size of a dataset) or in NLP applications that deal with new items (new unseen sentences). And it is in fact sentence embeddings, rather than word embeddings, that better capture text semantics and allow for better NLP task accuracy.

The higher-resolution representation of a document with a typically variable-size collection of the (fixed-size) embedding vectors is also not suitable for downstream tasks such as those that use neural networks expecting one fix-size vector per NLP document as input, which would be desirable for many NLP applications. It should also be noted that if the number of vectors in the collection would be fixed, the concatenation of the vectors could be used as one fix-size vector, but this is also not practical due to the resulting high dimensionality of such a vector and is inherently not suitable for representing documents of variable size.

In summary, no NLP method is known that features at the same time high accuracy, high scalability, and high speed for common multi-sentence NLP tasks on large datasets. Here, ‘high’ means very close or better regarding the considered metric when compared to all other solutions. However, such a characteristic would clearly be desirable for many practical NLP applications.

### SUMMARY

According to one aspect of the present invention, a computer-implemented method for generating a fixed-size N-dimensional vector representation for a given document may be provided. The method may include extracting text-portions from a plurality of documents, embedding the extracted text-portions into fixed-sized K-dimensional text-portion vectors, clustering the text-portion vectors into N clusters C_1, C_2, . . . , C_N, and generating an N-dimensional document vector E(D) for a document D by (i) associating its nth coordinate value E(D)_n to the nth cluster C_n. (ii) if not previously done for the document D then extracting text-portions from the document D and embedding the extracted text-portions into K-dimensional text-portion vectors, and (iii) setting the values E(D)_n based on similarity matching score values between the text-portion vectors of the document D and text-portions vectors of the N clusters.

According to another aspect of the present invention, a related embedding system for generating a fixed-size N-dimensional vector representation for a given document may be provided. The system may include one or more processors and a memory operatively coupled to the one or more processors, where the memory stores program code portions which, when executed by the one or more processors, enable the one or more processors to extract text-portions from a plurality of documents, to embed the extracted text-portions into fixed-sized K-dimensional text-portion vectors, and to cluster the text-portion vectors into N clusters C_1, C_2, . . . , C_N. The one or more processors may also be enabled to generate an N-dimensional document vector E(D) for a document D by (i) associating its nth coordinate value E(D)_n to the nth cluster C_n. (ii) if not previously done for the document D extracting text-portions from the document D and embedding the extracted text-portions into K-dimensional text-portion vectors, and (iii) setting the values E(D)_n based on similarity matching score values between the text-portion vectors of the document D and text-portions vectors of the N clusters.

Furthermore, embodiments may take the form of a related computer program product, accessible from a computer-usable or computer-readable medium providing program code for use by or in connection with a computer or any instruction execution system by or in connection with a computer or any instruction execution system. For the purpose of this description, a computer-usable or computer-readable medium may be any apparatus that may contain means for storing, communicating, propagating or transporting the program for use by or in connection, with the instruction execution system, apparatus, or device.

### BRIEF DESCRIPTION OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments to which the invention is not limited.

Preferred embodiments of the invention will be described, by way of example only, and with reference to the following drawings:

FIG. 1 shows a block diagram of an exemplary embodiment of the inventive computer-implemented method for generating a fixed-size vector representation for a given document.

FIGS. 2a and 2b show more implementation-near flows, starting from a plurality of documents at the top, down to practical applications of the proposed concept, according to an exemplary embodiment.

FIG. 3 shows a flowchart a general logical flow of activities for the proposed method, according to an exemplary embodiment.

FIG. 4 shows a flowchart of activities of a first step of the general logical flow of activities, according to an exemplary embodiment.

FIG. 5 shows a flowchart of activities of a second step of the general logical flow of activities, according to an exemplary embodiment.

FIG. 6 shows a flowchart of activities of a third step of the general logical flow of activities, according to an exemplary embodiment.

FIG. 7 shows a flowchart of the general logical flow of FIG. 3 applied to a prediction of scores or classes, according to an exemplary embodiment.

FIG. 8 shows a flowchart of the general logical flow of FIG. 3 applied to a further processing using a neural network for a net promoter score, according to an exemplary embodiment.

FIG. 9 shows a block diagram of an embodiment of the inventive embedding system for generating a fixed-size vector representation for a given document, according to an exemplary embodiment.

FIG. 10 shows an embodiment of a computing system including the system according to FIG. 9, according to an exemplary embodiment.

### DETAILED DESCRIPTION

In the context of this description, the following technical conventions, terms and/or expressions may be used:

The term ‘fixed-size vector representation’ may denote a vector with a predefined dimension—e.g., K-dimensional or N-dimensional—that may represent a certain text portion of a document or the entire document, respectively. Typically, the technique of embedding may be used to derive such a representation.

The term ‘text-portion’ or other systematically determined parts of the text may be any portion that may be extracted from a text or document. It may be a word, a phrase, a sentence, a double sentence, a paragraph, a chapter or the whole document. Other systematically separated portions of a text document may also fall under this definition.

The term ‘embedding’ may denote a relatively low-dimensional space into which one may translate high-dimensional inputs such as natural language sentences. Embeddings make it easier to do machine-learning on large inputs like sparse vectors representing words or sentences. Ideally, an embedding may capture some of the semantics of the input by placing semantically similar inputs close to each other in the embedding space. An embedding may be learned and reused across language models.

The term ‘cluster’ may denote a plurality of vectors having a comparably small distance to each other (e.g., a Gaussian distance) if compared to other vectors in the same hyperspace having a larger distance to the vectors of the cluster. Clustering is a well-known technique in the field of statistical mathematics.

The term ‘text-portion vector’ may denote and embedding vector created from a text-portion of a document.

The term ‘text-portions vectors of the N clusters’ may denote all embedding vectors for all portions of the entire plurality of the documents used.

The term ‘similarity matching score value’ may denote a mathematically real value which results from a comparison of two expressions. Typically, a semantically similarity can be expressed by the similarity matching score value such as well-known cosine similarity between two vectors.

The term ‘best matching text-portion vector’ may denote a vector representing a text portion which has the shortest distance (i.e., the highest similarity) if compared to other vectors of a given set. The text portion vector may be an embedding representation of the text portion.

The term ‘multi-resolution cluster’ may denote that a cluster of embedding vectors, here, the text-portion vectors, may include embeddings from not only one category of a source portion of the document, like only words, but also from other categories of text portions of a document, like sentences, phrases, paragraphs, partial sentences, chapters as well as the whole document or only words.

The term ‘clusters vocabulary’ (CV) may denote a set of clusters C_n created from the text-portion vectors, i.e., CV={C_n, n=1, . . . , N}. Unlike e.g., a vocabulary of words, the items of the vocabulary CV are the clusters itself, i.e., one cluster is one item of the vocabulary CV. The clusters C_n of the clusters vocabulary (CV) may be created only from the text-portions of the same type, e.g., only from the embeddings of sentences. But there is also a possibility to create different parts of the CV from different types of text-portions. One subset of the CV could be created from sentences, another from paragraphs, yet another from chapters, etc.

Alternatively, one subset may be created from sentences, another from two subsequent sentences, yet another from four subsequent sentences, etc. In the latter case, the n sentences window could move by one sentence (overlapping), or by n sentences (non-overlapping). This should be denoted Multi-Resolution Clusters Vocabulary (MRCV), and this may still produce fixed-size document representation, though potentially longer and computationally more demanding.

While MRCV is not the simplest and minimum form of the disclosed invention, it is a very important embodiment and a novelty per se.

MRCV enables discovering and explaining similarity of documents at multiple resolutions, i.e., at different sizes of document parts or portions being very similar, which for some NLP used might be useful or even very important.

The choice to use multi-resolution, which variant of it, and how many clusters at each resolution level may depend on the NLP use case.

To save on the resulting vector size, one might consider using the same set of clusters at multiple resolutions, if that might be advantageous for a considered use case. Embedding individual documents would of course have to follow the same rules as creating CV or MRCV.

MRCV may profit from a use of sparse representation of vectors that allow more efficient vector storage and operations when many of the coordinates are zero.

Before turning to the advantages of the proposed concept, it is worth looking in more detail into existing solution to understand their concepts, realistic characteristics and also disadvantages in order to value the real advantages of the newly proposed solution.

Word embedding approaches [compare “Efficient Estimation of Word Representations in Vector Space”, https://arxiv.org/abs/1301.3781; Also published at: 1st International Conference on Learning Representations, ICLR 2013, Scottsdale, Arizona, USA, May 2-4, 2013, Workshop Track Proceedings, 2013] assign words to hyper-dimensional vectors, such that when two words are more semantically similar, their corresponding vectors are closer together in vector hyperspace for a given NLP domain of interest represented by a large enough sample or selection of texts or documents.

In an example, for a general English language represented by a Wikipedia article, an unsupervised method can be used to assign the words of a finite vocabulary (e.g., 3 million most used words) to high-dimension vectors (e.g., 1024 real numbers per vector) with the above-mentioned semantic similarity property.

This may allow to replace simple counting of appearance of the same words across two documents with accounting for appearance of not necessarily the same but also semantically similar words in compared documents, which may improve the accuracy of various NLP tasks. The main and obvious limitation of this approach is that a word is still assigned the same generic vector, which clearly prevents from accounting for the specific context of the word in a particular text or document.

Consequently, the embedding methods were developed that account for word context when embedding the word as part of a sentence or a larger text part, the so-called contextual word embeddings [compare “BERT: Pre-training of Deep Bidirectional Transformers for Language Understanding”, https://arxiv.org/abs/1810.04805; also published at: North American Chapter of the Association for Computational Linguistics (NAACL-HLT), 2019, Minneapolis, MN, USA—Volume 1]. This way, e.g., the vector for “green” followed by “technology” will be closer to the vector for “ecological” then to the vector for “green” followed by “color”. This further improved the accuracy of the word-embedding-based NLP methods.

A contextual word embedding approach is also used for embedding sentences. For example, a sentence embedding is simply the average of contextual word embeddings of the sentence words, but other more advanced variants have been developed, including those not strictly limited to individual words or individual sentences, thereby expanding the spectra of the existing contextual word and sentence embedding approaches.

The mentioned contextual embeddings for words and sentences may exhibit, however, serious limitations when used with the existing NLP methods for processing multi-sentence texts or documents, which is the case in many NLP use cases. An existing approach [compare, “From Word Embeddings to Document Distances”, https://proceedings.mlr.press/v37/kusnerb15.html, see also in “Proceedings of the 32nd International Conference on Machine Learning”, Lille, France, 2015. JMLR: W&CP volume 37] represents a multi-sentence text or a document with the average or a weighted average of the embedding vectors (Words Centroid) of the constituent words or sentences, and evaluates similarity of two documents by computing the distance between their centroids (Word Centroid Distance, or WCD). It has been found this often does not work well unless the texts or documents are very short, as the vector averaging causes a loss of specificity for similarity matching.

Another existing approach considers a text or a document as a bag of words or sentences and their corresponding embedding vectors and evaluates similarity between two documents by using a method such as Word Mover Distance (WMD), which essentially maps the words of one document to the words with the most similar embedding vectors in another document, and determines the overall similarity from the similarity of the mapped word pairs, using averaging, weighted averaging, or similar.

One limitation of the WMD-like approaches is computational complexity as well as capturing semantic similarity only on the word level and not on the sentence and higher levels. WMD approaches may accelerated by using Linear-Complexity Relaxed Word Mover's Distance (LC RWMD) [compare “Linear-complexity relaxed word mover's distance with GPU acceleration”, https://arxiv.org/abs/1711.07227; also published at: 2017 IEEE International Conference on Big Data (Big Data 2017) Dec. 11-14, 2017, Boston, MA, USA], which may require a use of fixed-size vocabulary and fixed embeddings. For use of LC RWMD, each word can also be embedded differently for a finite number of different contexts, but then occupies one vocabulary entry for each supported context.

The WMD approach can and has been applied also on sentence level, these being the so-called Sentence Mover Distance (SMD) approaches [compare “Sentence Mover's Similarity: Automatic Evaluation for Multi-Sentence Texts”, https://aclanthology.org/P19-1264.pdf; also published at Proceedings of the 57th Annual Meeting of the Association for Computational Linguistics, January 2019]. Those simply use sentences and sentence embeddings instead of words and word embeddings, but the same limitations apply.

However, it is important to understand that, for large data sets, the fixed vocabulary size limitation for using the LC RWMD speedup method makes this method impractical (not computationally efficient and not scalable) at the sentence level, i.e., in SMD approaches. With large datasets the number of different sentences usually goes far beyond the 3 million vocabulary size of the exemplary most frequent English words vocabulary used in, e.g., Word2Vec embeddings. Also, at the sentence level, LC RWMD is not applicable to datasets that are continually updated with new documents, since the new documents may contain sentences that are not in the vocabulary.

There is also an existing approach [compare “Word Mover's Embedding: From Word2Vec to Document Embedding”, https://arxiv.org/abs/1811.01713; also published at Conference on Empirical Methods in Natural Language Processing (EMNLP), page 4524-4534 (2018)] that avoids direct (i.e., explicit) averaging of document text-parts embeddings, and yet creates a fixed-size vector as the document representation. It represents (embeds) a document with a vector of its WMD distances to a set of referent (coordinate) randomly created documents. Averaging is however still present implicitly because all the document parts contribute the computed/stored distances to all the coordinate documents, which negatively impacts the accuracy and explainability of the results of NLP tasks that would use this type of embedding. The embedding process itself is also not efficient because it is based on WMD except when used with finite word vocabulary, but this limitation also limits the accuracy. Moreover, the random word sampling (possibly in a weighted manner) from the dataset of interest, when creating the coordinate documents, also contributes to the unwanted implicit averaging (information loss/neglect) further reducing the achievable accuracy of NLP tasks that use this embedding.

When compared to this known status of technology and disadvantages, the proposed computer-implemented method for generating a fixed-size vector representation for a given document may offer a multiple advantages, technical effects, contributions and/or improvements:

The presented solution addresses the mentioned disadvantages of known solutions of embedding. This may be achieved by creating a fixed-size vocabulary in which each item may represent a cluster of similar text portions (i.e., text parts) arts found in a set of documents representative for an NLP domain of interest, and using that vocabulary (the clusters) to represent (embed) a variable-size multi-sentence text or document with (into) a fixed-size vector.

The coordinates of that fixed-size vector may correspond to the created clusters and the values assigned to the coordinates may depend on the similarity matching of the document text-parts embedding to the corresponding clusters, i.e., to the vectors of each cluster or to a representative vector of each cluster (e.g., cluster center).

One aspect of the proposed solution is to create the fixed-sized vocabulary, in which each item is represented by a cluster of similar text portions found in the set of documents representative for an NLP domain of interest and using this vocabulary (i.e., the clusters) to represent (i.e., embed) a variable-sized multi-sentence text or document with (into) a fixed-sized vector. The coordinates of that fixed-sized vector may correspond to the created clusters and the values assigned to the coordinates depend on the similarity matching of the document text-portion embeddings to the corresponding clusters, i.e., the vectors of each cluster or to the representative vector of each cluster, e.g., the cluster center, e.g., a centroid of the respective cluster. This means that the vocabulary items are therefore neither words nor sentences (as in traditional solutions), but the clusters of semantically similar text portions (e.g., semantically similar sentences). Each vocabulary item, i.e., each cluster, may thus represent a statement or a concept (with a distinguished meaning) present in the considered domain, expressed in different documents via often different, but semantically similar, sentences or text-portions of which the text-portion vectors belong that cluster.

This way, a document embedding can preserve most of the relevant semantic information of each of its sentences (and/or text portions), even if the number of sentences (and/or text portions) in the data set is extremely large and/or does not result in sentences and documents known before establishing the vocabulary items, i.e., the clusters.

The novel representation thus be advantageous as it may allow for similarity matching at a resolution and accuracy similar to WMD/SMD approaches, and it may also allow for a good explainability of the results, i.e., information is available about which text portions contributed most, and how much, to a result of similarity search, prediction, classification, etc., similar to WMD/SMD approaches. However, unlike those approaches, and due to the novel fixed-sized vector representation of documents, it may feature high computational efficiency, speed, and scalability, for common multi-sentence NLP tasks on large datasets, and may be used in advanced NLP pipelines that, e.g., include further processing via neural networks.

In the following, additional embodiments of the inventive concept, applicable for the method as well as for the system, will be described.

According to an embodiment of the method, each of the text-portions may be selected out of the group comprising a word, several subsequent words, a phrase, i.e., a couple of subsequent words in a semantic context, e.g., a half-sentence, a sentence, a double-sentence, multiple (e.g., subsequent) sentences, a paragraph, chapter and the document, several subsequent paragraphs, or combinations of these or similar text parts. Hence, from a word up to the complete document each possible isolation of text portion should be possible. It is expected that the most commonly used form would be the form of a sentence as text-portion.

According to a possible embodiment of the method, the plurality of documents may be associated with a knowledge domain. This may deliver the best results. Having “any document out of the Internet” would be too complex. Because the proposed method may generate its own dictionary or vocabulary, it would be beneficial to stay within one knowledge domain, like healthcare, semiconductor, intellectual property, programming, fuel cells or quantum computing, just to name a few. The documents of the plurality should relate more or less to the same topic; i.e., there should preferably be a common semantic denominator for all the documents.

According to an advantageous embodiment, the method may also comprise updating, which may also include ‘setting’ or setting newly, an E(D)_n value if a similarity matching score value between the text-portion vector of the document D and the best matching text-portion vector from C_n is larger than the same similarity matching score value toward the text-portion vectors from other N-k clusters. Here, k is a parameter determining how many coordinate values may be updated based on one text-portion, e.g., a sentence, or from the document, etc. The top k largest similarity matching score values corresponding to specific coordinate values will be updated. The remaining coordinate values are not touched when processing the current text-portion of D. Other coordinate values of the E(D)_n value may be changed when processing other text-portions of D. Because k is a configurable parameter, this embodiment may represent a definition of a threshold value defining the number of coordinate values E(D)_n of the resulting embedding vector that may be updated when processing one text-portion of D.

According to a preferred embodiment of the method, the text-portions may be multi-resolution text-portions and the clusters may be multi-resolution clusters. In short, a single-resolution cluster may be one which may comprise only embedding vectors of a single category of text types like one of a document, a sentence, a paragraph, a chapter and a word. If the embedding vectors relate to a mixture of different text types, the clusters are denoted as multi-resolution clusters.

According to an enhanced embodiment, the method may also include processing further the N-dimensional document vectors E (D), and indeed typically, a plurality of them, for one selected out of the group including document scoring, document classification, document similarity search, document similarity explanation, and document clustering. In particular, the document similarity explanation may be achieved by emphasizing text summaries of the clusters of the best-matching coordinates of two compared document vectors, and emphasizing the corresponding text-portions of the two compared documents that best match those clusters. The newly proposed concept may be integrated into an NLP or machine-learning pipeline and may actively support the concept of XAI (explainable Artificial Intelligence).

Furthermore, the processing-further the N-dimensional document vectors E(D) may also comprise any NLP algorithm that takes as inputs fixed-size vectors of documents, and any NLP algorithm that takes as inputs fixed-size vectors of documents and the embedding vectors of the corresponding fixed-size-vocabulary items, i.e., here the representative vectors of the clusters vocabulary.

In particular, and according to another enhanced embodiment of the method, the processing further may be performed using a neural network system. In an embodiment, an input layer of the neural network may receive embedding vectors which may have been generated by the method proposed here.

According to a useful embodiment of the method, the document D may be selected out of the plurality of documents or it is a new document. I.e., the documents of the plurality may get new embedding vectors using the method proposed, instead of using the original embedding techniques used for the fixed-sized embedding text-portion vectors.

According to an advantageous embodiment of the method, the vectors of a cluster may be represented by a centroid vector of the cluster or another average for the vectors of the cluster. As a consequence, no comparison may be required for each single vector of the cluster. Instead, for reasons of computational efficiency, only the centroid vector may need to be used as a representative for the computing of the semantic similarity between text-portion vectors of a document and the cluster. This is possible, because all vectors of the clusters have the same fixed size, i.e., number of dimensions. And in case of averaging with a cluster, there is no significant information loss because a cluster may comprise similar vectors corresponding to semantically similar text portions.

Optional, and available only if the documents from which the clusters are created are labeled, each cluster j may be assigned a class k promotion score (cpkj) for one or more classes of interest, calculated, e.g., as the percentage of the cluster j vectors that originate from documents labeled as class k. A cpkj score may be used for better explaining importance of a document text-part to the overall score or predicted class result, i.e. a document text-parts better matching the clusters with a high cpkj may be more important in explaining a classification of the document as class k.

According to an advanced embodiment, the method may also include: upon changing the number of the plurality of documents, typically, the number grows, the method may include adjusting the values of K and N. This may also include the case that N and/or K is/are left unchanged, which may represent the typical case. Furthermore, and according to this embodiment, the method may comprise re-clustering the text-portion vectors of the plurality of documents, and re-generating the document vector of document D. Typically, this may happen for all documents for which document (embedding) vectors exist.

In the following, a detailed description of the figures will be given. All instructions in the figures are schematic. Firstly, a block diagram of an embodiment of the inventive computer-implemented method for generating a fixed-size vector representation for a given document is given. Afterwards, further embodiments, as well as embodiments of the related embedding system will be described.

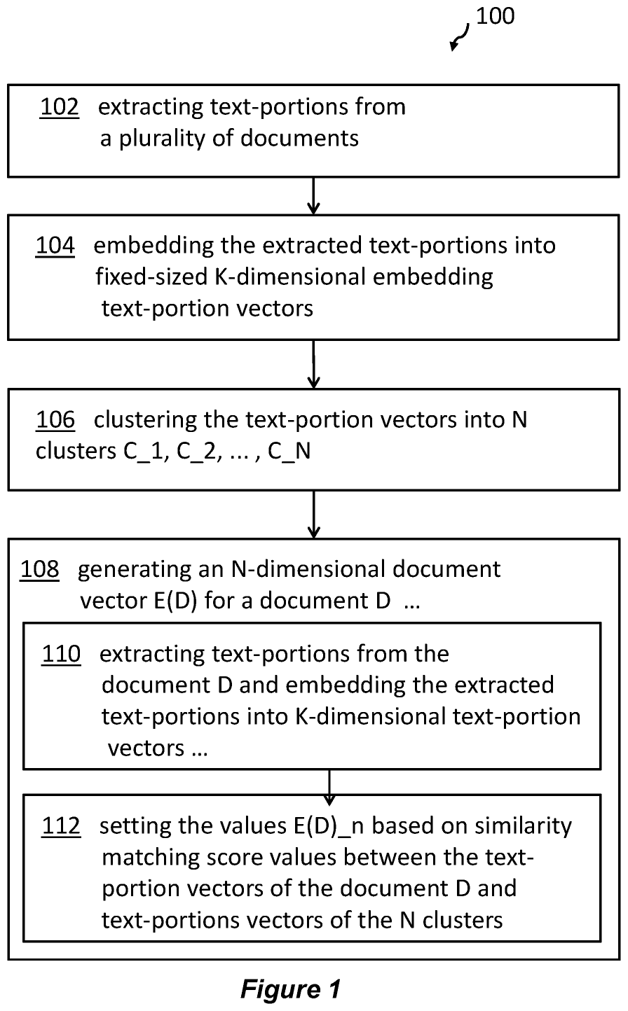

FIG. 1 shows a block diagram of a preferred embodiment of the computer-implemented method 100 for generating a fixed-size N-dimensional vector representation for a given document, according to an embodiment. The method includes extracting. 102, text-portions, which can be sentences, phrases, paragraphs, chapters and the like and even single words, from a plurality of documents. Typically and advantageously, the documents are from a problem or knowledge domain.

The method 100 includes embedding. 104, the extracted text-portions into fixed-sized K-dimensional embedding text-portion vectors having a dimension not necessarily equal to N (typically a different dimension than N). For this, known technology, e.g., BERT (Bidirectional Encoder Representations from Transformers) or other transformers may be used. A typical number of dimensions should be in the range of a couple of hundred. However, the method is not limited to this; it can also be configured to work with thousands, several tens of thousands or increased dimensional hyperspaces. A number smaller than the mentioned several hundred can deliver satisfactory results.

The method 100 includes clustering. 106, the embedding text-portion vectors into N clusters C_1, C_2, . . . , C_N, where N is a configurable parameter. The clustering can be based on a relative distance of the vectors to each other, e.g., the Euclidian distance or a cosine-similarity based distance. Once the clusters are built, an arbitrary indexing/ordering of the obtained clusters can be performed so that they can be identified by their index.

The method 100 includes generating, 108, a vector, namely an N-dimensional document vector E(D) for a document D, which is the fixed-sized N-dimensional vector representation for the given document, by associating its nth coordinate value E(D)_n to the nth cluster C_n. The generating includes extracting. 110, text-portions from the document D and embedding the extracted text-portions into K-dimensional text-portion vectors if not previously done for the document D, by setting. 112, the values E(D)_n based on similarity matching score values between the text-portion vectors of the document D and text-portions vectors of the N clusters. It should also be noted that the activities of extracting. 110, and the activity of setting. 112, are shown as sub-portions of the generating. 108, the N-dimensional document vector E (D) for the document D because the generating. 108, is based on the extracting 110 and the setting 112.

For the similarity function any similarity function may be used, e.g., cosine similarity. As a result, the new N-dimensional document vector is the newly created embedding of the document. It may undergo further processing like classification, clustering, etc., e.g. using a neural network.

The novel and inventive method for document embedding delivers a novel representation of documents by first embedding the sentences and/or other systematically determined text parts from the currently available problem domain representative documents into vectors and clustering the obtained embedding vectors. Then any already available or newly obtained document is embedded via: (i) matching the embeddings of its sentences (and/or text parts/portions) against the previously created clusters. Matching is performed, e.g., via evaluating similarity between a document-sentence vector and the vectors of a cluster or a vector representative of a cluster (cluster center), and (ii) considering each cluster as a coordinate of the document embedding vector and using the number and similarity of the top matches (per document text part and/or per cluster) to set the coordinate value, e.g., as a counter, or the cumulative similarity, or a binary (matched or not matched) value.

The document embeddings then can be used to efficiently compare similarity of documents, e.g., via computing the inner product of document pairs. Other NLP tasks can also be done efficiently, such as: unsupervised or supervised clustering by using standard fixed-sized vector-based clustering algorithms, or supervised training of a classifier or predictor, e.g., using a neural network. Any NLP algorithm assuming a fixed-size vocabulary can be used for further document processing, including the computationally more extensive algorithms (or their optimizations) that take as input not only the produced document vectors but also the cluster-representative vectors, such as, e.g., Word Mover Distance algorithm wherein the words vocabulary is replaced with the clusters (vocabulary), word embeddings are replaced with the cluster-representative vectors (e.g., the cluster centroids), and the sparse vector, indicating the number of each word in the document, is replaced with the document vector created according to concept proposed here.

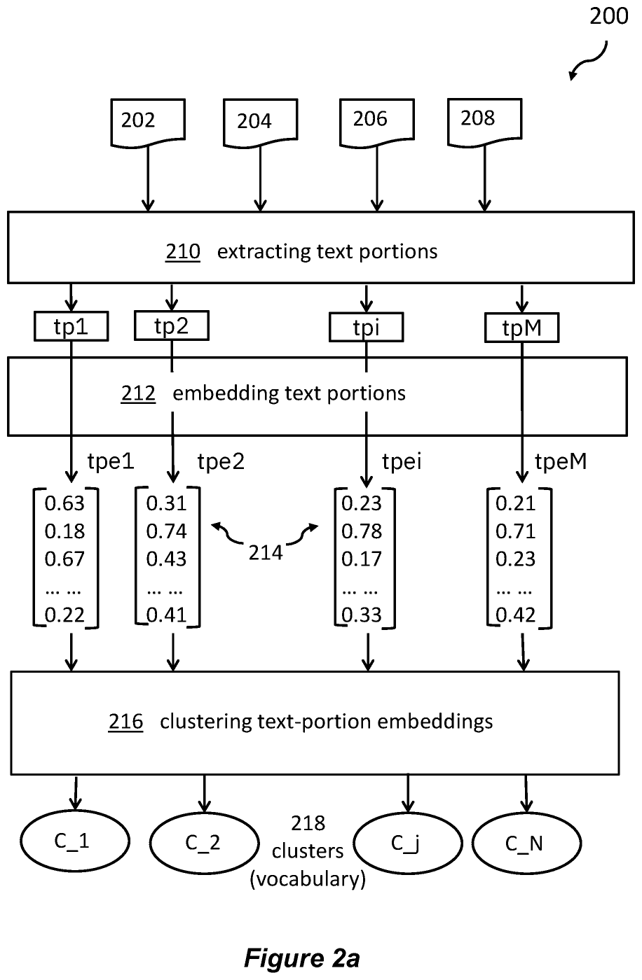

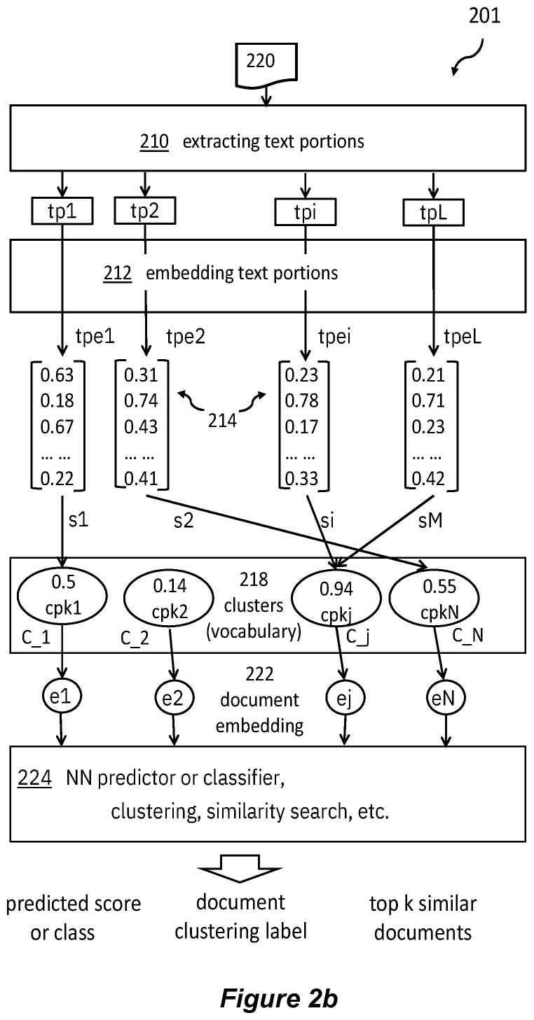

FIGS. 2a and 2b show an implementation of flows 200 and 201, starting from a plurality of documents at the top, down to practical applications of the proposed concept, according to an exemplary embodiment. Initially, as shown in FIG. 2a, from the documents 202, 204, 206 and 208 different text portions, e.g., sentences, terms, paragraphs, chapters, . . . and the like, are extracted, 210, as tp1, . . . , tpM and undergo an embedding procedure 212, where the text-portion embedding vectors tpe1, . . . , tpeM 214 are generated. These vectors have all the same dimension K.

These vectors, which have a certain similarity to each other, are then clustered, 216, into a plurality of clusters C_1, . . . , C_N, 218. These clusters can be understood as a fixed-size vocabulary built from the plurality of documents 202, . . . , 208, wherein the four shown documents represent graphically a large plurality of documents in the range of 10s of thousands, 100s of thousands or several million or a billion or more documents.

After the clusters are created, a document embedding vector (e1, e2, . . . , eN) 222 is created for a single document 220 which is a document from the previously used plurality of documents or a new document, as shown in FIG. 2b. From the single document 220 the text-portions are extracted, 210, as tp1, . . . , tpL and undergo the embedding procedure 212, where the text-portion embedding vectors tpe1, . . . tpeL 212 are generated. These vectors 214 have all the same dimension K. Then, for each text-portion vector of tpei, i=1, . . . . L similarities sij to each of the clusters C_j, j=1, . . . , N (reference numeral 218) are determined, using, e.g., cosine similarity or another common similarity function. The sij may be determined as the maximum similarity between the tpei and each of the text-portion vectors of cluster Cj, or it can be determined as the similarity between tpei and the representative text-part vector of cluster Cj. Top k sij values determine top k most similar clusters Cj, and the corresponding k coordinates of the document vector (e1, . . . , eN) 222 are set or updated, e.g., as a counter, or the cumulative similarity, or a binary (matched or not matched) value, for each text-part tpi. For simplicity, FIG. 2b shows only si as the top-1 sij value across j=1, . . . , N. The same procedure may be repeated for each of plurality documents Dn, n=1, . . . , Nd, producing one document vector (e1, . . . , eN) n for each document Dn.

The document vector or a plurality of document vectors (e1, . . . , eN) n, n=1, . . . , Nd, 222 can then be fed to an input layer of, e.g., a neural network 224 which can be used for a further-processing, e.g., for clustering, similarity search, as well as for the mentioned document similarity explanation, i.e., as an implementation of the concept of XAI (explainable Artificial Intelligence).

Optionally, and available only if the documents from which the clusters are created are labeled, each cluster j may be assigned a class k promotion score (cpkj) for one or more classes of interest, calculated, e.g., as the percentage of the cluster j vectors that originate from documents labeled as class k. cpkj scores may be used for better explaining importance of a document text-part to the overall score or predicted class result, i.e., a document text-parts better matching the clusters with a high cpkj may be more important in explaining a classification of the document as class k.

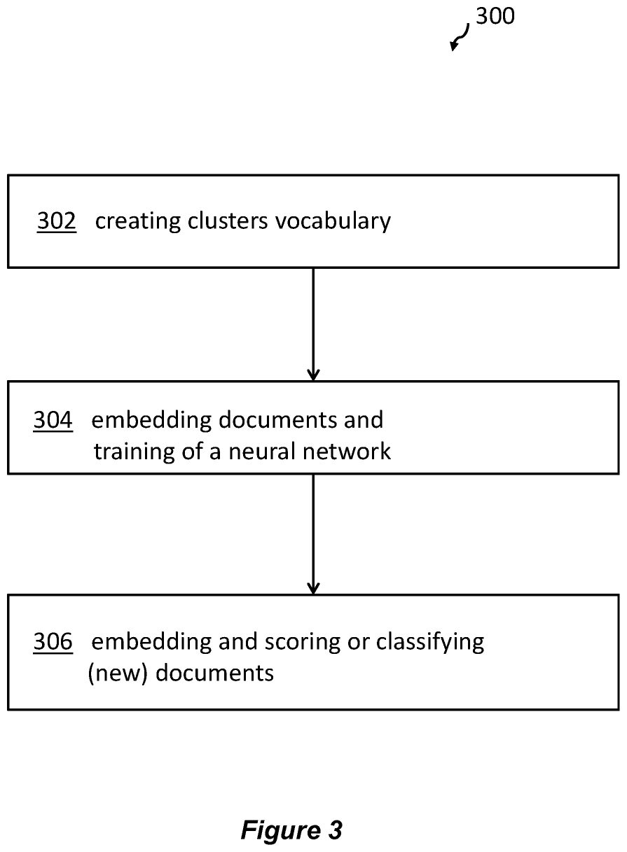

FIG. 3 shows a flowchart 300 of a general logical flow of activities for the proposed method, e.g., the main phases ‘prepare’, ‘train NLP pipeline’ and ‘score/classify documents’, according to an exemplary embodiment. These phases are represented by creating the cluster vocabulary, 302, embedding the documents and training the neural network, 304, and embedding and scoring or classifying (new) documents, 306. These activities will be detailed in the following figures from a different perspective than already done.

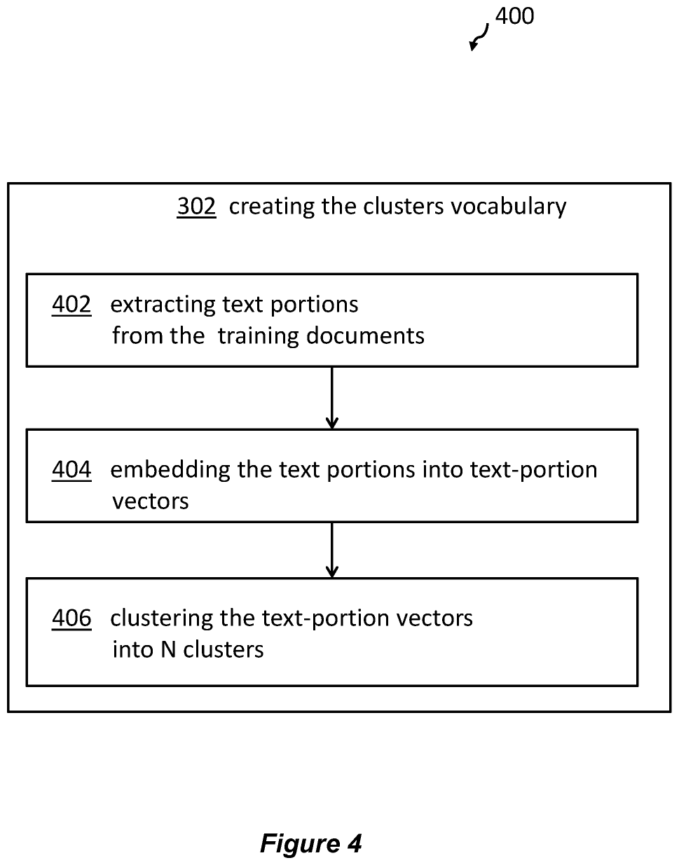

FIG. 4 shows a flowchart 400 of activities of the first phase of the general logical flow of activities, according to an exemplary embodiment. It is related to the creating, 302, the clusters vocabulary 302. Seen from a higher level, these are 402: extract text portions from the training documents, i.e., the plurality of documents; 404: embedding the text portions into text-portion vectors; and, clustering, 406, the text-portion vectors into N clusters. Each of the N clusters is an item of the clusters vocabulary. However, this process can also be executed on the documents of the plurality of documents, i.e., the training data.

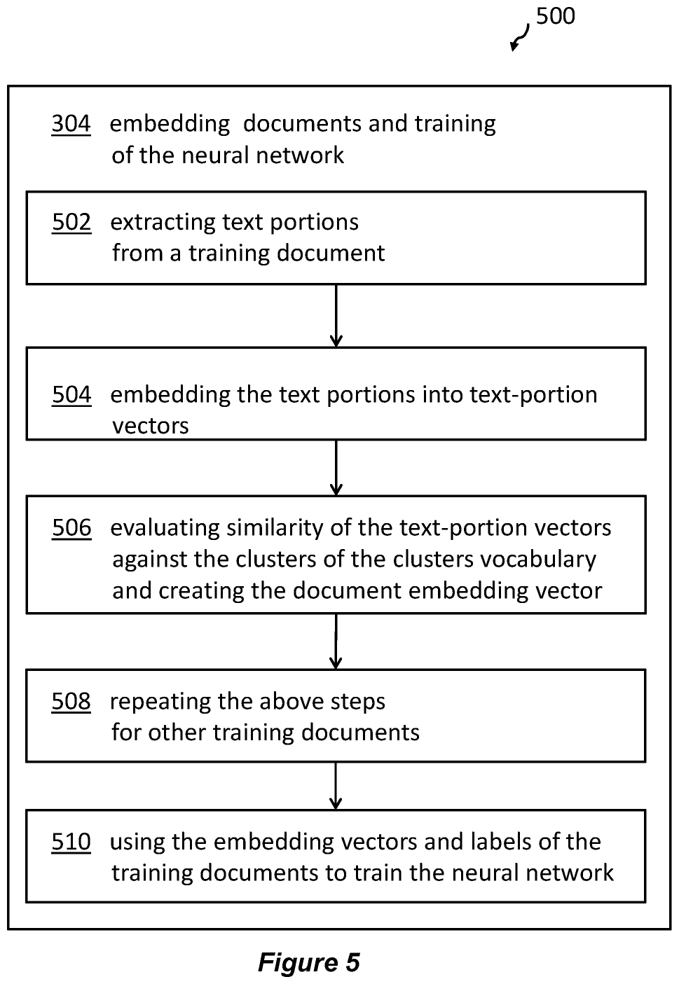

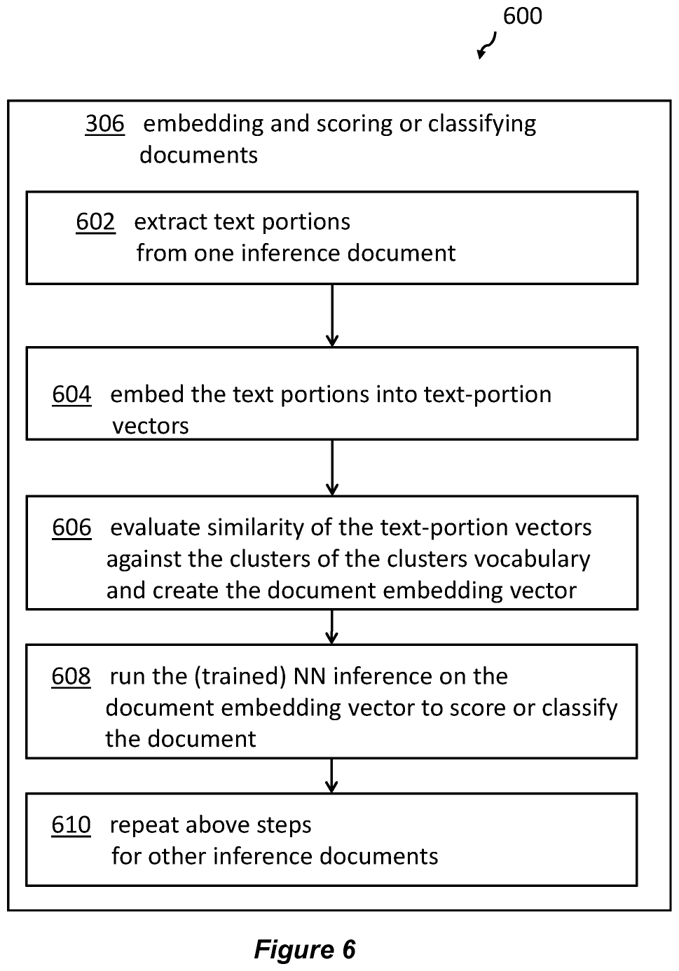

The training documents used are not required to be labeled, because this part is based on clustering and can work in an unsupervised manner. The set of documents used in this part can be the same or different from the documents in the parts described in the context of FIGS. 5 and 6, but it should be representative enough, i.e., it should cover semantically similar topics as those expected to appear in the activities described in the context of FIGS. 5 and 6.

In an embodiment, the set of documents used in the context of the activities of FIG. 4 should be a very generic large set of, e.g. English, text documents, e.g. from Wikipedia, similar as it was used for pre-trained word2vec (word-to-vector) and BERT embedders. In that case, the obtained cluster vocabulary would be generic and representative—though not fully optimized—for any English text NLP data set and tasks.

Clusters vocabulary optimized for a specific problem domain or a specific data set would be created by using the existing documents of the considered problem domain, potentially in combination with generic English text documents.

Another option for creating clusters vocabularies is to start from a clusters vocabulary of a larger dimension (i.e., a larger number of clusters) and fine-tuning for a specific domain by merging some clusters and/or adding new clusters based on the content of the problem-domain documents.

FIG. 5 shows a flowchart 500 of activities of a second phase of the general logical flow of activities, namely embedding documents and train the neural network, 304, according to an exemplary embodiment. This series of activities is characterized, at a high level, by 502: extracting the text portions from the training documents (or other documents); 504: embedding the text portions into text-portion vectors; 506: evaluating a similarity of the text-portion vectors against the clusters of the clusters vocabulary and creating the document embedding vectors; 508: repeating the above steps for other (training) data; and 510: using the embedding vectors and labels of the training data to train the neural network. This high level activity flow should help to fully understand the more detailed explanation given above.

A document text portion contributes to the document embedding vector in the following way. The text portion embedding is matched against the vectors in the clusters of the clusters vocabulary. The top or closest matching coordinates identify the cluster to which the text portion contributes. Each cluster corresponds to one coordinate of the document embedding vector.

The contribution may be setting the corresponding document vector coordinate bit to “1”, e.g., if matched by at least one text portion from the document. Alternatively, each text portion match can increment the counter or increase the value of the corresponding coordinate.

Alternatively, it will increase the corresponding coordinate value by the similarity value with the matched vector, e.g., by a normalized similarity in a product.

And further alternatively, if the documents from which clusters are created are labeled, the cluster scores cpkj can also be used to modulate the coordinate j value. Optionally, after all coordinates are set, thresholding or normalization can be applied.

FIG. 6 shows a flowchart 600 of activities of the third phase of the general logical flow of activities, namely the step of embedding and scoring or classifying (new) documents, 306, according to an exemplary embodiment. Also here, from a high-level perspective, the sequenced activities are as follows: 602: extract the text portions from one interference document; 604: embed the text portions into text-portion vectors; 606: evaluate a similarity of the text-portion vectors against the clusters of the clusters vocabulary and create the document embedding vector; 608: run the trained neural network interference on the embedding vector to score or classify the (new) document or perform any other task on that created document embedding vector. If the task is clustering documents, document vectors for multiple documents (e.g., one per document) need to be created and passed as input to the clustering documents task. If required, the above described step can be repeated, 610, for other inference documents.

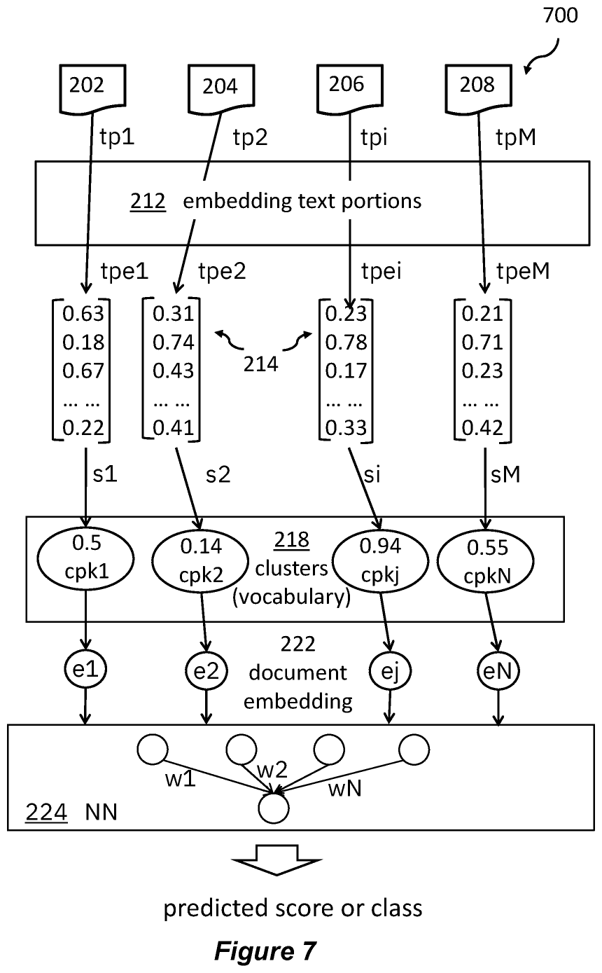

FIG. 7 shows a flowchart 700 of the general logical flow of FIG. 2b applied to a prediction of scores or classes, according to an exemplary embodiment. Here, elements that have been mentioned in the context of FIG. 2 will not be explained again (the extraction 210 is not shown here). For FIG. 7, the focus should be directed to the lower part of the figure, where the document embedding 222 (e1, . . . , eN) is fed to a neural network 224 which is symbolically equipped with different weighting factors w1, . . . , wN in order to predict a score for the document in question (FIG. 2, 220, not shown) or related to a predefined class of documents in the context of the plurality of documents 202, . . . , 208 (compare FIG. 2a).

In addition to the comparably simple scorings and classifications, the proposed NLP pipeline may also be used for explainability. Unlike other fixed-sized vector document embeddings, the disclosed document embedding method has a good resolution in representing document text portions, and therefore, can also enable an explanation of the results of the NLP task.

In case of the score prediction of classification task in the pipeline of FIG. 7, an explanation in the form of the top contributors to the result can be provided as follows:
explanation=sort {(expl_score_i, expl_text_i)}, where
   expl_text_i=f_t(tpi) and
   expl_score_i=f_s(si, cpkj, δScore/δej)

The explanation text expl_text_i can be the raw text portion tpi, or the summary of the corresponding top matching cluster for tpi. The explanation score for the tpi contribution to the NLP task result, expl_score_i, can be determined as a product or a more complex function f_s of: the text portion to vocabulary cluster similarity si, the cluster score cpkj based on associated labels of its elements to class k, if the labels are available; otherwise, the neutral value of “1” can be used and the gradient δScore/δej of the NLP_result change with respect to the document coordinate ej which corresponds to the value of tpi. Thereby, f_t represents a function over the text portion tpi and f_s represents the scoring function.

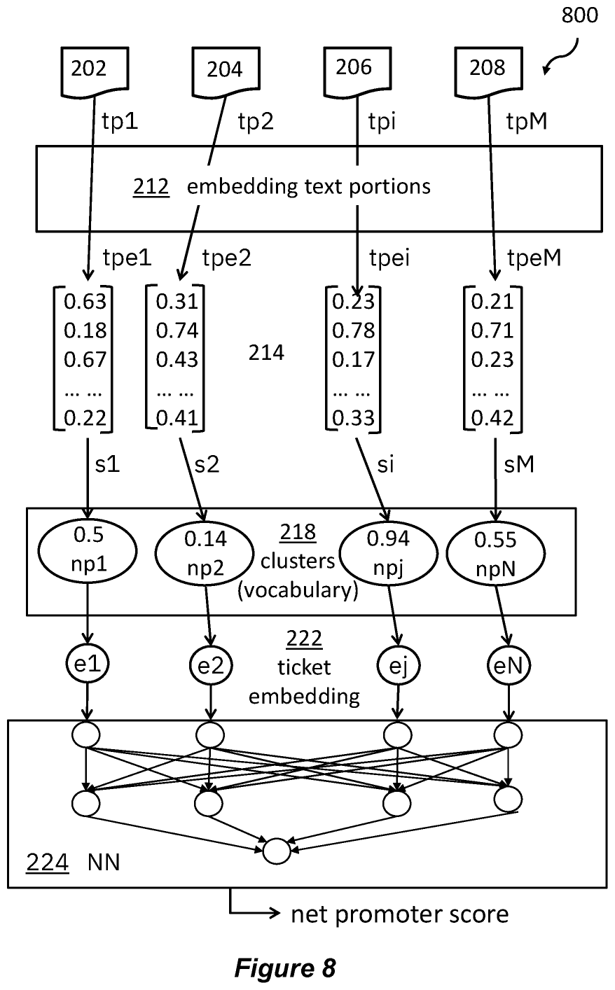

FIG. 8 shows a flowchart 800 of the general logical flow of FIG. 2b applied to a further processing using the neural network 224 for a net promoter score, according to an exemplary embodiment. Here, examples of a representative set of documents (i.e., the plurality of documents, as mentioned above) is a set of the past customer-issue support tickets along with their updates which represent a specific domain, i.e., the mentioned knowledge domain. More particularly, the set of documents can also be a set of the past slack messages (messages of the known SLACK messaging system) of a slack channel which represents a comparably narrow specific domain.

Experimentally, the proposed method has been applied to the past tickets in a prototype as part of an NLP pipeline for predicting “net promoter score” (NPS) for customer-issued tickets handled by a technology service provider company, which uses the (unstructured) textual content of tickets and their updates. A value for the NPS is given by customers after a ticket is closed to express their satisfaction about how the ticket is handled. One of the goals of predicting NPS is to alert the support staff on the tickets that have a chance of getting low NPS, so they can take proactive action. As a result of the experiment, better NPS prediction accuracy results with the new NLP pipeline could be achieved based on the proposed novel document embedding if compared to an open-source implementation of a state-of-the-art solution aimed for this type of NLP tasks, when applied to the same unstructured tickets text data.

In this example there are two classes of the training tickets, the net promoters and net non-promoters, therefore it makes sense to compute and use cpkj for at least one of the two classes, e.g. for the net promoter class, denoted on the figure as npj.

This example shows how otherwise computationally expensive tasks can be performed using less resources and consume less power (better efficiency), thus also supporting ecological objectives.

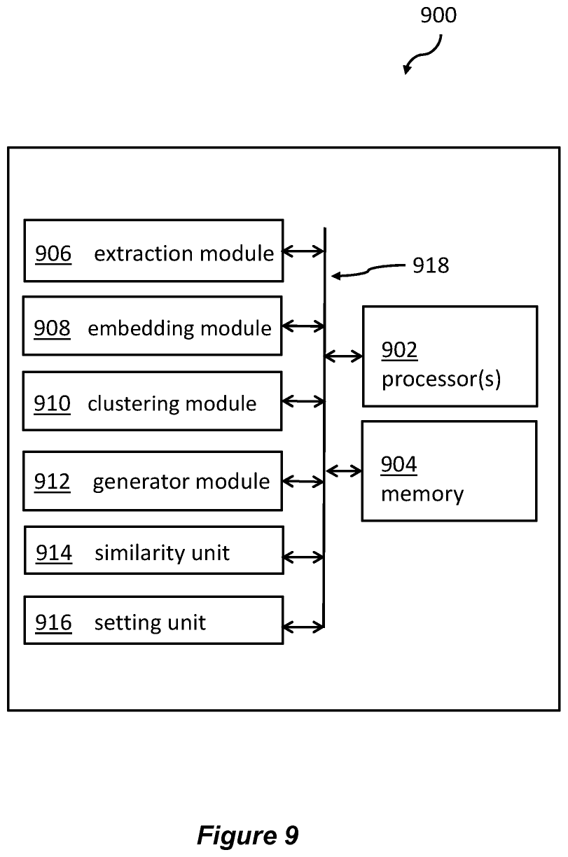

FIG. 9 shows the embedding system 900 for generating a fixed-size vector representation for a given document, according to an exemplary embodiment. The system 900 comprises one or more processors 902 and a memory 904 operatively coupled to the one or more processors 902, wherein the memory 904 stores program code portions which, when executed by the one or more processors 902, enable the one or more processors 902 to extract text-portions from a plurality of documents. This may be done by an extraction module 906.

The one or more processors 902 also enabled to embed the extracted text-portions into fixed-sized (embedding) text-portion vectors—in particular, by an embedding module 908—and, to cluster the embedding text-portion vectors into N clusters C_1, C_2, . . . , C_N. This may be performed by a clustering module 910.

Additionally, the one or more processors 902 also enabled to generate, in particular, by its generator module 912, an N-dimensional document vector E(D) for a document D by associating its nth coordinate value E(D)_n to the nth cluster C_n, and to extract, in particular, by an extraction module 906, text-portions from the document D and embedding the extracted text-portions into K-dimensional text-portion vectors by an embedding module 908 if not previously done for the document D. Finally, the one or more processors are also enabled to set, in particular, by a setting unit 916, the values E(D)_n based on similarity matching score values computed, by a similarity unit 914, between the text-portion vectors of the document D and text-portions vectors of the N clusters.

All functional units, modules and functional blocks, in particular the processor(s) 902, the memory 904, the extraction module 906, the embedding module 908, the clustering module 910, the generator module 912 the similarity unit 914, and the setting unit 916, may be communicatively coupled to each other for signal or message exchange in a selected 1:1 manner. Alternatively, the functional units, modules and functional blocks can be linked to a system internal bus system 918 for a selective signal or message exchange.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

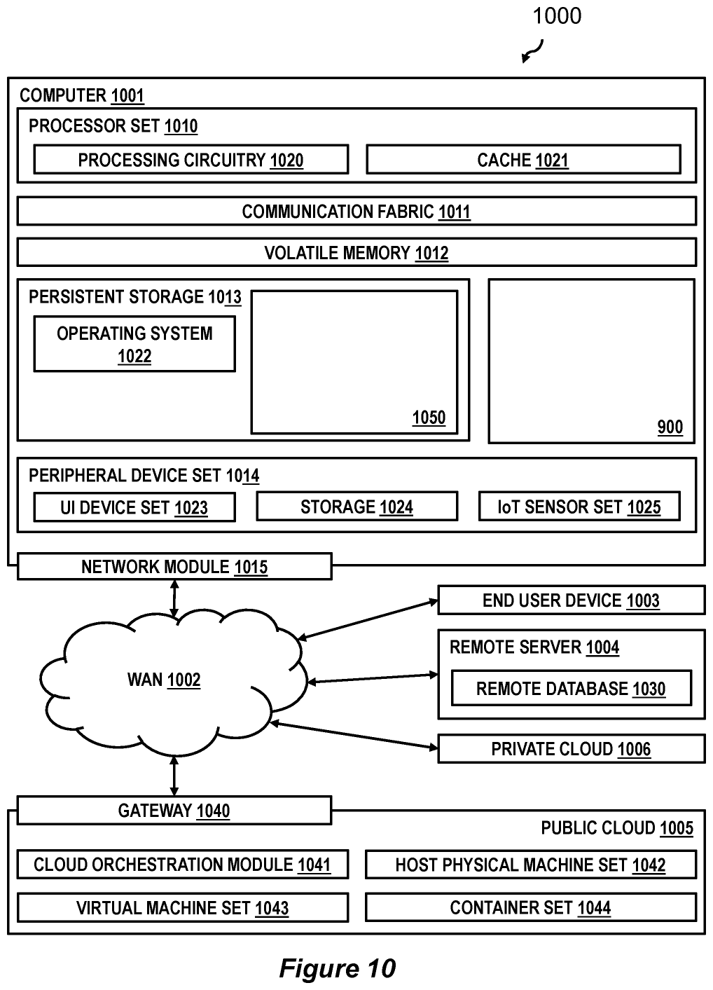

FIG. 10 shows a computing environment 1000 comprising an example of an environment for the execution of at least some of the computer code involved in performing the inventive methods, such as the computer-implemented method for generating a fixed-size vector representation for a given document 1050, according to an exemplary embodiment.

In addition to block 1050, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1050, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1050 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1050 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (e.g., embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way. EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

It should also be mentioned that the embedding system (FIG. 4900) for generating a fixed-size vector representation for a given document can be an operational sub-system of the computer 1001 and may be attached to a computer-internal bus system.

The terminology used herein is for the purpose of describing particular embodiments only and is not intended to limit the invention. As used herein, the singular forms a, an and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method for generating a fixed-size N-dimensional vector representation for a given document, the method comprising:
extracting text-portions from a plurality of documents;
embedding the extracted text-portions into fixed-sized K-dimensional embedding text-portion vectors;
clustering the text-portion vectors into N clusters C_1, C_2, . . . , C_N;
generating an N-dimensional document vector E(D) for a document D by
associating its nth coordinate value E(D)_n to the nth cluster C_n,
extracting text-portions from the document D and embedding the extracted text-portions into K-dimensional text-portion vectors, and
setting the values E(D)_n based on similarity matching score values between the text-portion vectors of the document D and text-portions vectors of the N clusters.

2. The method according to claim 1, wherein
each of the text-portions is selected out of the group comprising a word, several subsequent words, a phrase, a sentence, a double-sentence, a paragraph, chapter and the document, several subsequent paragraphs, similar text parts and a combinations of these.

3. The method according to claim 1, wherein
the plurality of documents is associated with a knowledge domain.

4. The method according to claim 1, further comprising:
updating an E(D)_n value when similarity matching score value between the text-portion vector of the document D and the best matching text-portion vector from C_n is larger than the similarity matching score value toward the text-portion vectors from other N-k clusters.

5. The method according to claim 1, wherein
the text-portions are multi-resolution text-portions and the clusters are multi-resolution clusters.

6. The method according to claim 1, further comprising:
processing further the document vectors N-dimensional document vector E(D) for one selected out of the group comprising document scoring, document classification, document similarity search, document similarity explanation, and document clustering.

7. The method according to claim 6, wherein
the processing further is performed using a neural network system.

8. The method according to claim 1, wherein
the document D is selected out of the plurality of documents or it is a new document.

9. The method according to claim 1, wherein
the vectors of a cluster are represented by a centroid vector of the cluster.

10. The method according to claim 1, further comprising:
upon changing the number of the plurality of documents, perform the following steps:
adjusting the values of K and N;
re-clustering the text-portion vectors of the plurality of documents; and
re-generating the document vector of the document D.

11. A computer system for generating a fixed-size N-dimensional vector representation for a given document, the computer system comprising:
one or more computer processors, one or more computer-readable storage media, and program instructions stored on the one or more of the computer-readable storage media for execution by at least one of the one or more processors, wherein the computer system is capable of performing a method comprising:
extracting text-portions from a plurality of documents;
embedding the extracted text-portions into fixed-sized K-dimensional embedding text-portion vectors;
clustering the text-portion vectors into N clusters C_1, C_2, . . . , C_N;
generating an N-dimensional document vector E(D) for a document D by
associating its nth coordinate value E(D)_n to the nth cluster C_n,
extracting text-portions from the document D and embedding the extracted text-portions into K-dimensional text-portion vectors, and
setting the values E(D)_n based on similarity matching score values between the text-portion vectors of the document D and text-portions vectors of the N clusters.

12. The computer system according to claim 11, wherein
each of the text-portions is selected out of the group comprising a word, several subsequent words, a phrase, a sentence, a double-sentence, a paragraph, chapter and the document, several subsequent paragraphs, similar text parts and a combination of these.

13. The system according to claim 11, wherein
the plurality of documents is associated to a knowledge domain.

14. The system according to claim 11, further comprising:
updating an E(D)_n value when similarity matching score value between the text-portion vector of the document D and the best matching text-portion vector from C_n is larger than the similarity matching score value toward the text-portion vectors from other N-k clusters.

15. The system according to claim 11, wherein
the text-portions are multi-resolution text-portions and the clusters are multi-resolution clusters.

16. The system according to claim 11, further comprising:
processing further the document vectors N-dimensional document vector E(D) for one selected out of the group comprising document scoring, document classification, document similarity search, document similarity explanation, and document clustering.

17. The system according to claim 16, wherein
the processing further is performed using a neural network system.

18. The system according to claim 11, wherein
the vectors of a cluster are represented by a centroid vector of the cluster.

19. The system according to claim 11 further comprising:
upon changing the number of the plurality of documents, perform the following steps:
adjusting the values of K and N;
re-clustering the text-portion vectors of the plurality of documents; and
re-generating the document vector of the document D.

20. A computer program product for generating a fixed-size vector representation for a given document, the computer program product comprising:
one or more computer-readable storage media and program instructions stored on the one or more computer-readable storage media, the program instructions executable by a computing system to cause the computing system to perform a method comprising:
extracting text-portions from a plurality of documents;
embedding the extracted text-portions into fixed-sized K-dimensional embedding text-portion vectors;
clustering the text-portion vectors into N clusters C_1, C_2, . . . , C_N;
generating an N-dimensional document vector E(D) for a document D by
associating its nth coordinate value E(D)_n to the nth cluster C_n,
extracting text-portions from the document D and embedding the extracted text-portions into K-dimensional text-portion vectors, and
setting the values E(D)_n based on similarity matching score values between the text-portion vectors of the document D and text-portions vectors of the N clusters.
